(19) United States
(12) Patent Application Publication
(10) Pub. No.: US 2009/0309244 A1
(43) Pub. Date: Dec. 17, 2009

(54) PROCEDURE AND DEVICE OF HIGH EFFICIENCY FOR THE GENERATION OF DROPS AND BUBBLES

(75) Inventor: Javier Dá Vila Martín, Sevilla (ES)

Correspondence Address: MERCHANT & GOULD PC, P.O. BOX 2903, MINNEAPOLIS, MN, 55402-0903, US

(73) Assignee: Universidad De Sevilla, Paseo de las Delicias s/n, Sevilla (ES)

(21) Appl. No.: 12/280,266

(22) PCT Filed: Feb. 16, 2007
(86) PCT No.: PCT/ES07/00089

§ 371 Date: Feb. 17, 2009

(30) Foreign Application Priority Data
Feb. 22, 2006 (ES) P200600467

(51) Int. Cl. B05B 7/08

(52) U.S. Cl. 261/77

(57) ABSTRACT

The invention relates to a method and device for generating drops or bubbles in liquids with a range of sizes which, under normal pressure and temperature conditions, can vary from hundreds of micrometres to several millimetres. When the liquid or gas to be dispersed is passed through small holes which open into a transverse current, menisci are formed, from which small drops or bubbles emanate. The fraction of energy used in the process, which takes the form of an increase in the surface of the liquid/liquid or liquid/gas interfaces, must be maximised in relation to the energy transferred to the system in order to render the generation of drops or bubbles as efficient as possible. The device can be used in the fields of oxygenation and aeration of liquids, chemical engineering and food technology.

### OBJECT OF THE INVENTION

This invention describes a procedure and device for generating drops and bubbles that covers a range of sizes from about a few hundreds of microns to several millimeters in normal conditions of temperature and pressure.

When the liquid or gas to disperse flows through small orifices that discharge into a liquid cross-flow a meniscus is formed at every orifice, from which small drops or bubbles are eventually detached. To make this generation of drops or bubbles as efficient as possible the fraction of energy that converts into an increase of surface of the liquid-liquid or liquid-gas interfaces must be maximized in relation to the total energy transferred to the system.

The device of the present invention is applicable to different fields, such as liquid Oxygenation or Aeration, Chemical Engineering and Food Industry, where the efficient generation of small gas bubbles or liquid drops inside a liquid current has an important role in the process. In most of those applications the objective is to maximize the contact surface between the phases.

### BACKGROUND OF THE TECHNIQUE

Existing methods of oxygenation or aeration are based on the increase of the contact surface between gas and liquid, with the aim of closing the gap between the actual oxygen concentration and the saturation value. The majority of the systems actually used (C. E. Boyd 1998, Acuicultural Engineering 18, 9-40) try to fragment an amount of liquid in air, which is then reincorporated to the liquid, or produce bubbles which are directly released into the liquid. Devices such as venturis, or some pumps which are simultaneously liquid propeller and air vacuum pumps, produce the fragmentation of a gas jet in the presence of liquid. However they have low efficiencies, since their Standard Aeration Efficiency (SAE) hardly exceed two kilograms of oxygen per consumed kilowatt-hour. The most efficient way to generate bubbles is injecting gas in a liquid co-flow. However, this means that to get large flow rates, hundreds or thousands of needles should be placed in the main stream. Thus it seems more interesting to perform the injection of the gas through a multitude of orifices performed in the main conduct wall, so that at the exit of these orifices the liquid cross-flow produces a large drag on the gas that comes out the orifices. This cross-flow setup may give rise to several regimes or modes (S. E. Forrester y C. D. Rielly 1998, Chemical Engineering Science 53, pág. 1517-1527), showed in FIG. 1.

The bubbling mode is observed at low gas flow rates of the dispersed fluid and is characterized by a regular production of close-to-spherical bubbles, of approximately the same size, which detach close to the orifice. The resulting diameter of the drops or bubbles is determined from a force balance equating the drag force produced by the main flow to the surface tension force. For this reason it is possible to obtain extremely small bubbles. However this mode of bubble formation has as a main disadvantage that, for the usual geometrical configurations, the ratio between the injected gas flow rate and the liquid flow rate is too low for applications of general interest, because the efficiency obtained is very low. For larger flow rates of the dispersed fluid a continuous jet is formed, anchored to the orifice exit, which eventually breaks in a chaotic way into irregular fragments. This is called as jetting mode, the buoyancy forces are then negligible and if the inertia of the injected fluid is also negligible the gas jet has, in the breakup region, a velocity which is very close to the surrounding liquid. In the absence of other important forces, the equivalent average diameter of the resulting bubbles can be approximated by (P. F. Wace, M. S. Morrell y J. Woodrow 1987, Chemical Engineering Communications 62, pág. 93-106)

d_{eq}≈2,4\sqrt{Q_{g/}uₗ},

where Q_{g} is the flow rate injected through the orifice and uₗ is the liquid velocity surrounding the jet. To complete the description of the possible modes just mention that the pulsating mode is an interim regime between the previous ones, and the cavity mode only appears for certain geometrical configurations at large flow rates of the dispersed fluid.

In the case that the formed bubbles, jet or cavity reach an area of developed turbulence of the liquid flow, the process of bubble generation is well documented in C. Martínez-Bazán, J. L. Montañes y J. C. Lasheras 1999 (Journal of Fluid Mechanics 401, pág. 157-182 y 183-207). In this case the turbulent stresses cause the bubble disaggregation and bubbles much smaller than the injection orifice can be produced if the Weber number based on the size of the flow structures in the breakup zone (l), the velocity of the liquid (uₗ) and the surface tension (σ) (We=ρₗuₗ² l/σ, where ρₗ is the liquid density) is sufficiently large. For this kind of breakup recent progresses have been made (A. Sevilla, Ph.D Thesis, University Carlos III of Madrid).

The device presented in this document favors the formation of small bubbles through the generation of intense shear zones in the flow. This means that the obtained bubbles may have sizes which are significantly smaller than the gas ligament from which they are generated. The fragmentation of bubbles by small shear structures is also the subject of a patent by Dávila and Gordillo 2004. From a conceptual point of view, the present invention has as main advantage with respect to the previous one that the bubbles are directly formed from the anchored meniscus, instead of from bubbles which have been generated by a different procedure, which is crucial to maximize the energetic efficiency.

The majority of the atomizing existing methods convert part of the energy supplied to the system (kinetic energy in the case of pneumatic atomizers, electric energy in sonic and piezoelectric ultrasonic atomizers, mechanical energy in rotating devices, electrostatic energy in the electro-hydrodynamic atomizers, etc.) into surface tension energy, since the area of the gas-liquid interface drastically increases in these processes. In the applications cited in this invention, this means that the supplied energy must increase when the size of the formed drops or bubbles decreases. However, in many atomizers (as is the case of the device described here) part of the energy is transferred to the fluid in the form of kinetic energy. This, together with the increment of the gas-liquid interface area allows a great increase of the transference of particles or ions through the interface. In any case, there will be an optimum from which an increase of the supplied energy does not imply an improvement of the efficiency of the process and vice versa, a decrease in energy provided for the atomization implies a reduction in yield.

### DESCRIPTION OF THE INVENTION

The objective of the present invention is a procedure and device of atomization and fragmentation of drops or bubbles within a stream of liquid. Among the many procedures normally employed to produce small size bubbles, this invention uses the injection through orifices into a cross-flow for the subsequent breakup into fragments that are typically in the millimetric range.

When a gas (or an immiscible liquid) is injected into a liquid cross flow a meniscus is created that subsequently detaches from the orifice, forming bubbles that are easily fragmented into other smaller bubbles, due to the shear (boundary layer) of the small structures in the main turbulent flow. Therefore, the device based on this procedure has an injection and a breakup stage that follow the injection of gas (or immiscible liquid) through small orifices by which also runs a liquid cross flow, reaching a velocity that is sufficient to produce a strong shear or high fluctuations that produce the breakup of the meniscus anchored to the orifice or of the bubbles that were detached from it. In this regard, the proposed procedure is similar to that of the venturis, which also recovers part of the kinetic energy supplied to the flow by means of a divergent nozzle located below the injection and breakup point. However, our device has the advantage that energy consumption is much lower, as the liquid flow rate is minimized and the bubbles detached from the orifices are substantially smaller.

Through this process, extremely small bubbles are obtained, being the main limit of constructive type. With mechanized of standard precision bubbles of a few tens of microns can be obtained, although in this case yields are not as high. As a bonus there is a high agitation of the mixture, considerably increasing the transfer of gas to liquid. Air and liquid flow rates can be controlled by regulation valves, reaching maximum efficiency when the speed of the liquid into the orifice is typically of the order of 10m/s and the flow rate ratio is of the order unity. In the case of oxygenation or aeration of water the standard aeration efficiency (SAE) can reach values much higher than 2 kg of oxygen per kilowatt-hour obtained in the best current systems.

The bubbles generated by this atomization method have the following properties:
1. They have a small size; in the range of diameters that typically varies among the tens of microns and a few millimeters.
2. They are moving within a turbulent flow, which favors further transfer from gas to liquid or from liquid to liquid in the case of the formation of emulsions of immiscible liquids.

This may allow, among other applications, an efficient dissolution of gases in liquids or, similarly, a substantial increase in the speed of reactions that occur in chemical gas-liquid or liquid-liquid reactors.

### DETAILED DESCRIPTION OF THE INVENTION

The formation of a meniscus anchored at the exit of an orifice is a result of the balance of drag, surface tension forces and inertia, as the effect of gravity tends to be negligible in this process. Depending on the geometry and velocities of the two fluids the meniscus breaks into small fragments resulting in very different sizes. It is used a parametric range (special set of value of the properties of fluids, size of the holes, flow rates, etc.) such that from the breakdown of the meniscus occur fragments with typical diameter of a few hundred microns, so that maximize energy efficiency if that is the objective. In other cases the target may be to reach the minor sizes possible at the expense of efficiency.

When the gas (or the liquid to disperse) and liquid flow rates are kept constant, a meniscus is formed at the orifice exit, in a laminar flow of liquid with an average velocity uₗ, applying a driving pressure to the liquid

$${P}_{O} = {P}_{S} + \frac{{k}_{l}}{2} {ρ}_{l} {u}_{l}^{2} ,$$

where P_{O} y P_{S} are, respectively, the pressure upstream and downstream of the device, ρₗ is the liquid density and kₗ the pressure drop coefficient of the driving liquid (Idelchik, Hemisphere, 1986). Likewise, a pressure must be applied to the gas to overcome the losses caused by the orifices

$${P}_{g} = {P}_{l} + \frac{{k}_{g}}{2} {ρ}_{g} {u}_{g}^{2} ,$$

where k_{g} is the orifice pressure drop coefficient, ρ_{g} is the gas density, u_{g} the gas velocity at the orifice and Pₗ the pressure at the discharge zone, which is linked to the pressure of the driving fluid through

$${P}_{l} = {P}_{O} - \frac{1}{2} {ρ}_{l} {u}_{l}^{2} ( 1 - \frac{{A}_{I}^{2}}{{A}_{O}^{2}} ) ,$$

where Aₗ and A_{O} are the area of passage in the gas injection zone and at the liquid entrance. It has been supposed that this transition of areas is smooth, so that the pressure drop is negligible. As a consequence Pₗ, and therefore also P_{g}, can be quite lower than P_{O} if uₗ is sufficiently large.

The Weber number (ratio between the dynamic or inertia forces and the surface tension forces) is

We=ρₗuₗ²d/σ,

where σ is the surface tension and d the diameter of the meniscus. In the range of interest for the applications here included the values of We use to be very large, what means that in the breakup process of a bubble or drop that would had a diameter of the order of that of the meniscus, the role of surface tension would not be relevant, being the dominant forces the pressure and dynamic forces. This means that through this procedure drops or bubbles of size much smaller than the meniscus can be produced, although from this breakup arise very different sizes. For example, in the breakup of air bubbles in water (σ=70 mN/m) in a flow with velocities of several meters per second, high values of the Weber number based on the diameter of the bubble can be obtained, with bubble sizes of a few tens of microns. Moreover, larger bubbles will also result when they reach zones where the shear is not very intense.

In this process the energy consumption arise from the drive of the two fluids (which is converted in enhancing surface energy, kinetic energy and viscous dissipation) and therefore can be calculated using the expression W=Wₗ+W_{g}=Qₗ (P_{O}−P_{S})+Q_{g} (P_{g}−P_{S}), where Qₗ is the flow rate of the liquid that provides the main stream and Q_{g} the flow rate of the gas or the dispersed liquid. For applications of oxygenation or dissolution of gases in liquids the standard aeration efficiency (SAE) in kg of O₂ per kWh can be obtained from

$$SAE = \frac{{α}_{g} {Q}_{g} {ρ}_{g} {Y}_{{O}_{2}}}{{\dot{W}}_{l} + {\dot{W}}_{g}}$$

where Q_{g} is expressed in m³/h, ρ_{g} in kg/m³ and the power in kW. α_{g} is the fraction of dissolved O₂ in the liquid with respect to the injected oxygen and Y_{O2} is the volumetric fraction of oxygen in the injected gas (0,21 for air under normal conditions).

To maximize energy efficiency the driving cost must be reduced without increasing the average size of the resulting bubbles and thus without decreasing in excess α_{g}. Since the bubble diameter depends on the velocity of the liquid and not on the liquid flow rate it is convenient to reduce as much as possible the area of passage of the conduit where the gas is injected. This can be achieved for example by introducing a streamlined body which at the same time that reduces the area of passage does not increase the pressure drop.

Taking into account the typical sizes of bubbles that occur (the largest bubbles are in the range of millimeters) and the properties of the turbulent flow in which they are immersed (with velocity fluctuations near the meter per second), it can be assumed that at least 50% of the oxygen will be dissolved in the liquid if the residence time of the bubbles in the tank of discharge is sufficiently long. Thus, for overpressures of just 0.1 bar (enough to achieve velocities greater than 10 m/s at the injection point if kₗ<0.2), in the case of using air under normal conditions (20° C. y 1 atm)

$$SAE = \frac{{Q}_{g}}{{Q}_{l} + ( {P}_{g} / {P}_{O} ) {Q}_{g}} 45 kg {O}_{2} / KWh .$$

It should be borne in mind that for flow rate ratios Qₗ/Q_{g} close to unity coalescence between bubbles frequently occurs, which imposes a minimum value of Qₗ/Q_{g}. Despite this the resulting efficiency can be very high, can reach more than 6 kg O₂/kWh, and although to these values the performance of the driving pump must be applied is clear that efficiencies higher than those obtained by usual procedures can be achieved.

### DESCRIPTION OF THE FIGURES

FIG. 1. Schematic representation of the different modes of breakup of drop or bubble in a cross flow: a) bubbling mode, b) pulsating mode, c) jetting mode and d) cavity mode.

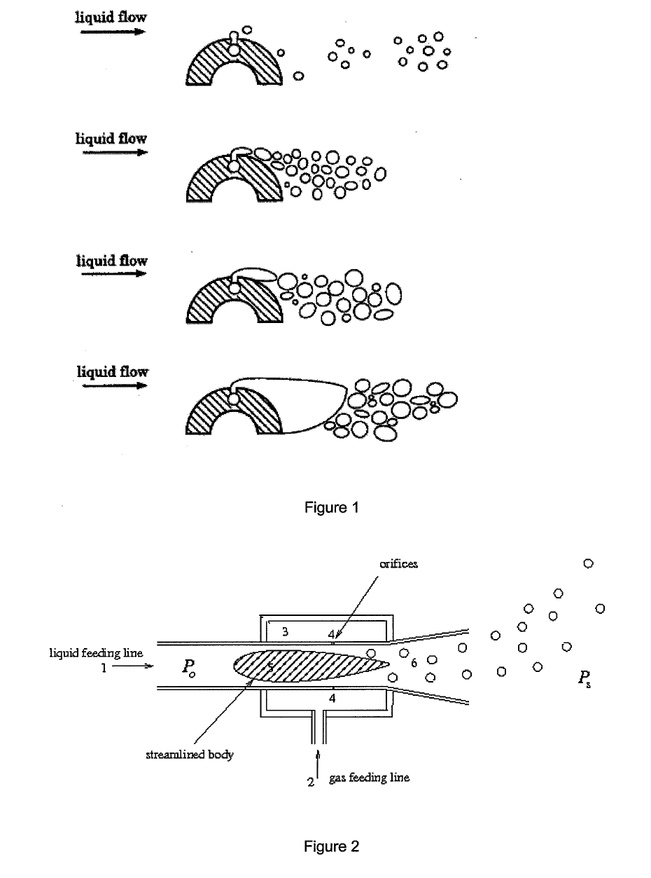

FIG. 2. To complement the description being done and to assist a better understanding of the characteristics of this invention FIG. 2 is accompanying this description as an integral part of it, as a matter of illustration and not as limitation, containing a model prototype of gas diffuser in liquids:
1. Conduit supply of liquid.
2. Gas supply.
3. Gas pressure chamber.
4. Orifices through which gas is injected.
5. Streamlined body.
6. Zone of breakup of bubbles.
P_{O}=liquid driving pressure.
P_{S}=pressure at the device exit.

### EXEMPLARY USES OF THE INVENTION

The proposed system for the development of this invention requires the provision of the driving liquid and gas or dispersed liquid flow rates. Both flow rates should be appropriate for the system to be within the parametrical range of interest to meet the specifications of a particular application. The number of orifices to inject the disperse fluid and the cross section of the main conduit at the injection site will be increased if the velocity of the liquid in this area is very high for the flows required and therefore the efficiency is very low as a consequence of excessive pressure upstream of the ducts. Likewise we may have several main channels through which the driving liquid flows arranged in parallel and in which the gas or liquid to disperse is injected across multiple orifices.

An increased driving liquid flow rate and gas or liquid to disperse flow rate can be supplied by any means in specific applications (oxygenation, gas-liquid or liquid-liquid chemical reactors, etc.) because it does not interfere with the functioning of the atomizer. Thus it can be used any methods of providing the driving liquid and the gas or liquid to disperse (compressors, volumetric pumps, compressed gas cylinders, etc.).

The driving liquid is introduced into a conduit with elongated cross section so that the orifices needed for the injection can be put along the wall for the injection in parallel of the fluid to disperse. This section may be formed through rectangular conduits with a ratio between their width and cross length smaller than 0.2 or annular conduits with a relationship between his inner and outer diameter larger than 0.8.

The flow rate of the fluid to disperse should be as homogeneous as possible between the different holes, which may require alternatively injection through porous media, perforated plates or any other method capable of distributing an homogeneous flow between different feeding points. The orifices through which the gas or liquid to disperse is introduced will have an opening between 0.001 y 3 mm.

The materials of which can be manufactured the atomizer are multiple (metal, plastic, ceramics, glass), depending primarily the choice of material on the specific application in which the device is going to be used.

FIG. 2 shows the outline of a prototype already tested, where the driving liquid is introduced through the entry (1) and the gas to disperse is introduced by other end of the system (2) in a pressurized chamber (3). In this prototype pressures have been used to supply gas to fragment from 0.05 to 2.5 bar above atmospheric pressure P_{S} to be unloaded. The entrance to the liquid impulsion pipe is at pressure P_{O}>P_{S}. The pressure of the gas supply should always be slightly higher than the liquid at the injection site, depending on the pressure drop across the gas injection system, to ensure a certain liquid/gas flow rate ratio. The key geometric parameters are the passage area of the liquid at the gas injection site and the geometry of the divergent nozzle located downstream of the injection in the area of fragmentation of the produced bubbles (6). In this prototype the gas injection was carried out through 36 orifices (4), with diameters of 0.3 mm. The section of the liquid impulsion pipe was ring-shaped, formed by a conduit of 20 mm inner diameter and a streamlined body (5) that at the injection point had a diameter of 18 mm. The angle of the divergent nozzle located downstream of the injection section was 20°. The remaining measures of the prototype in no way affect the generation and fragmentation of the bubbles as long as the gas pressure chamber has large dimensions (length and diameter) compared with the orifices.

1-28. (canceled)

29. A device for generating drops or bubbles in a liquid, comprising a conduit through which circulates the liquid, and a chamber containing the fluid to disperse in the form of drops or bubbles in the liquid flowing through the conduit, whose conduit and chamber are interconnected through orifices that separates the conduit and the chamber, characterized by that the cited orifices are all placed in one cross section of that conduit or within a tolerance distance less than five times the average distance between the orifices to a certain cross section of the conduit.

30. A device of claim 29, wherein the conduit through which circulates the fluid has circular section and within which a streamlined body is placed, between whose surface and the conduit wall a narrow annular passage for the liquid is determined, in coincidence with it are placed the cited orifices which are surrounded by the chamber containing the fluid to disperse.

31. A device of claim 30, wherein a ratio between the inner and the outer diameter of the annular passage at the injection site where the orifices are placed larger than 0.8.

32. A device of claim 29, wherein the conduit through which circulates the fluid has a rectangular section of width smaller than 0.2 times its cross length.

33. A device of claims 31, wherein having more than ten orifices connecting the conduit and the chamber containing the fluid to disperse with sizes between 0.001 mm and 3 mm.

34. A device of claims 31, wherein a width of the passage for the liquid flow between 0.001 mm and 10 mm.

35. A procedure of generation of drops or bubbles using a device of claim 31, wherein a velocity of the liquid at the injection site where the orifices are placed between 0.001 m/s and 20 m/s.
